(19) United States
(12) Patent Application Publication
(10) Pub. No.: US 2012/0313397 A1
(43) Pub. Date: Dec. 13, 2012

(54) PROTECTION SYSTEM FOR SHOPPING CARTS

(76) Inventor: MICHELLE CARTER, Mililani, HI (US)

(21) Appl. No.: 13/350,971

(22) Filed: Jan. 16, 2012

Related U.S. Application Data
(60) Provisional application No. 61/494,606, filed on Jun. 8, 2011.

(51) Int. Cl. B60P 7/02

(52) U.S. Cl. 296/100.01

(57) ABSTRACT

A cover for a shopping cart may include a top configured to overly a basket and a handle of the shopping cart. Vertical sides may be attached to the top and may extend downwardly from the top to fit loosely over the cart.

### RELATED APPLICATIONS

This application claims the benefit of U.S. Provisional Patent Application No. 61,494,606 filed on Jun. 8, 2011.

### BACKGROUND OF THE INVENTION

The present invention generally relates to shopping cart covers and more particularly to a system for making such covers readily available to users of the shopping carts.

During inclement weather, goods in a shopping cart may be ruined as they are transported from the grocery store to a car or other destination. Thus, a cart cover that is made from weather resistant material may allow purchased products to be transported from the store to a vehicle, in wet environments may be needed.

In many instances a rainstorm may arise while a shopper is in a store buying his or her merchandise. When the customer is ready to leave the store, the customer may be unprepared to cover the contents of the shopping cart to protect the contents from rain.

As can be seen, there is a need for a system in which a customer may avail themselves of a protective cover for a shopping cart when he or she is ready to leave a store during a rainstorm.

### SUMMARY OF THE INVENTION

In one aspect of the present invention, a cover for a shopping cart may comprise: a top configured to overlie a basket and a handle of the shopping cart; and vertical sides attached to the top and extending downwardly from the top to fit loosely over the cart.

In another aspect of the present invention, a method for providing customers of retail stores with protective covers for shopping carts in the event of inclement weather may comprise the steps of: providing a shopping cart cover to a customer at an exit of the store; and collecting the cover after a customer has moved merchandise from the store to his or her vehicle.

These and other features, aspects and advantages of the present invention will become better understood with reference to the following drawings, description and claims.

### BRIEF DESCRIPTION OF THE DRAWINGS

FIG. 1 is a perspective view of a shopping cart cover in accordance with an embodiment of the invention;

FIG. 2 is an exploded view of the cover of FIG. 1 showing an underlying shopping cart; and

FIG. 3 is a perspective view of a staging area for shopping carts and a dispenser for the covers of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide systems for providing customers of retail stores with protective covers for shopping carts in the event of inclement weather.

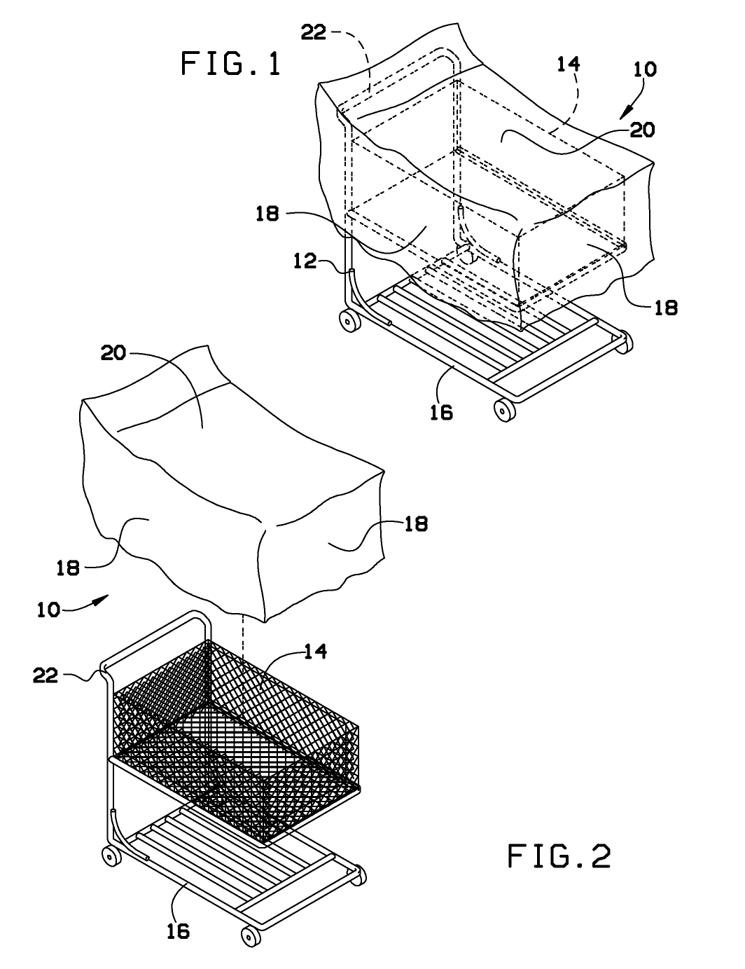

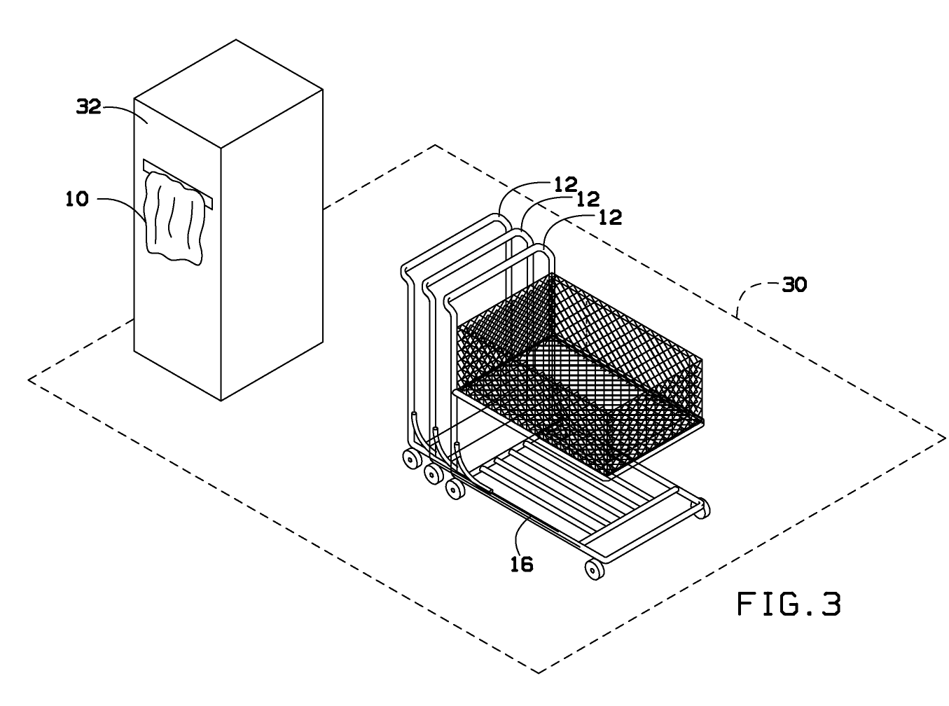

Referring to FIGS. 1 and 2, it may be seen that a shopping cart cover 10 may be configured to loosely fit over an entire shopping cart 12. In one embodiment, the cover 10 may have vertical sides 18 which are long enough to cover a basket 14 of the cart 12. In another embodiment, the cover 10 may have vertical sides 18 long enough to cover the basket and a bottom rack 16 of the cart 12. A top 20 of the cover 10 may be large enough to cover the basket 14 and a handle 22 of the cart 12.

The cover 10 may be constructed from light weight water-resistant fabric with sewn seams joining the vertical sides 18 and the top 20. In such an embodiment the cover 10 may be considered to be re-usable. In others words, a retailer might provide such fabric covers to a customer with an expectation that the fabric covers will be left with the cart 12 after the customer has loaded merchandise into his or her vehicle. The fabric covers may then be collected by an employee of the retailer when the employee collects the carts from a parking lot.

In an alternative embodiment, the cover 10 may be constructed from light weight plastic film such as polyethylene with fused seams. The film covers may be provided to a customer for one-time use with an expectation that after the customer has removed merchandise from the cart 12, the film cover may be deposited in a collection bin for material recycling.

Referring now to FIG. 3, it may be seen that a retailer may provide a shopping cart staging area 30. Within the area 30, the retailer may place a dispenser 32 for the covers 10. The dispenser 32 may be positioned near an exit of a store. Advantageously, the dispenser 32 may be placed between checkout stations of the store and the exit. In that regard, the retailer may be assured that customers may not place additional merchandise into a covered cart after the customer has passed through checkout.

It should be understood, of course, that the foregoing relates to exemplary embodiments of the invention and that modifications may be made without departing from the spirit and scope of the invention as set forth in the following claims.

What is claimed is:

1. A cover for a shopping cart comprising:
a top configured to overlie a basket and a handle of the shopping cart; and
vertical sides attached to the top and extending downwardly from the top to fit loosely over the cart.

2. The cover of claim 1 wherein the vertical sides are long enough to extend below a basket of the cart but not a bottom rack of the cart.

3. The cover of claim 1 wherein the vertical sides are long enough to extend below a basket and a bottom rack of the cart.

4. The cover of claim 1 wherein the top and vertical sides are constructed from fabric with sewn seams.

5. The cover of claim 4 wherein the fabric is water-resistant fabric.

6. The cover of claim 1 wherein the top and vertical sides are constructed from recyclable plastic film.

7. The cover of claim 6 wherein the film is polyethylene.

8. A method for providing customers of retail stores with protective covers for shopping carts in the event of inclement weather comprising the steps of:
providing a shopping cart cover to a customer at an exit of the store; and
collecting the cover after a customer has moved merchandise from the store to his or her vehicle.

9. The method of claim 8 further comprising the step of re-dispensing the cover to a subsequent customer after the cover is collected.

10. The method of claim 8 further comprising sending the cover for material recycling after the cover is collected.
